(19) United States
(12) Patent Application Publication
(10) Pub. No.: US 2017/0089608 A1
(43) Pub. Date: Mar. 30, 2017

(54) FLUID PROCESSING SYSTEM AND RELATED METHOD

(71) Applicant: Ohio University, Athens, OH (US)

(72) Inventor: Jason Patrick Trembly, Athens, OH (US)

(21) Appl. No.: 15/126,463

(22) PCT Filed: Mar. 23, 2015
(86) PCT No.: PCT/US2015/021961

§ 371 Date: Sep. 15, 2016

Related U.S. Application Data
(60) Provisional application No. 61/969,547, filed on Mar. 24, 2014.

(51) Int. Cl. F24H 1/20; H05B 3/00; H05B 3/03; C02F 1/02

(52) U.S. Cl. CPC F24H 1/203; C02F 1/02; H05B 3/0004; H05B 3/03; C02F 2101/32

(57) ABSTRACT

A fluid processing system and method of processing a fluid includes a tank having an outer wall, a heating element, and an insulating element. The heating element is situated within the tank and includes a first electrode and a second electrode. The insulating element is positioned between the first electrode and the second electrode. As such, powering the heating element directs an electric current through the fluid within the tank for heating the fluid, while the insulating element provides electrical and thermal insulation to the outer wall of the tank.

### CROSS-REFERENCE TO RELATED APPLICATION

This application claims priority to U.S. Provisional Patent Application No. 61/969,547, entitled “FLUID PROCESSING SYSTEM AND RELATED METHOD,” filed on Mar. 24, 2014, which is expressly incorporated by reference herein in its entirety.

### TECHNICAL FIELD

The present invention generally relates to the processing of fluids, and more particularly, to processing fluids with heat.

### BACKGROUND

Heat is often used to process fluids, such as water-based compositions having various impurities. For example, heat can be used to process water that is recovered from hydrocarbon collection sites. Particularly, water may be pumped into a well at a hydrocarbon collection site as part of a process of collecting hydrocarbons from the well. The water typically becomes mixed with various impurities or other materials during the hydrocarbon collection process, thereby forming a working fluid. The working fluid often requires processing in order to separate the water from the various or other impurities.

It is known, for example, to place such working fluids into a large tank and heat the tank in order to indirectly heat the working fluid inside the tank. A heat source is often applied to the tank itself and the heat transfers through a wall of the tank to heat the working fluid inside the tank. After a period of time, the heat source eventually increases the temperature of the working fluid to a desirable temperature. However, the energy absorbed by the tank itself is essentially wasted. Typically, fluid processing systems that use this method of heating working fluid by heating the tank directly require a tank constructed of substantially thick material, such as a relatively thick metal, in order to sustain the stresses created by heating the tank wall as part of the process of heating the working fluid therein.

It is also known to use a heating element inside a tank to directly heat a working fluid. For example, known designs present a risk of electrical shock to people working in the area of the tank, because the tank itself acts as an electrode of the heating element. When the heating element is activated, electricity flows through the tank material and thereby presents a risk of electrical shock.

There is a need for a fluid processing system and method of processing a working fluid that reduces energy consumption, improves safety, and addresses present challenges and characteristics such as those discussed above.

### SUMMARY

The present invention provides an improved fluid processing system. To this end, and in accordance with principles of the present invention, a fluid processing system includes a tank configured to receive a fluid and having an outer wall, and a heating element situated in the tank and configured for heating the fluid. The heating element includes a first electrode and a second electrode. The fluid processing system further includes an electric power supply configured to provide electric current to the heating element. The fluid processing system also includes an insulating element positioned in the tank between the second electrode and the outer wall of the tank. The insulating element provides electric and thermal insulation.

In accordance with further principles of the present invention, a method is provided for processing a fluid using a processing system that includes a tank having an outer wall, a heating element situated in the tank and including a first electrode and a second electrode, and an insulating element positioned in the tank between the second electrode and the outer wall of the tank. The method includes directing electric current between the first electrode and the second electrode to heat the fluid in the tank.

Various additional objectives, advantages, and features of the invention will be appreciated from a review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic cross-sectional view of an exemplary embodiment of a fluid processing system.

FIG. 2 is an enlarged schematic cross-sectional view of the fluid processing system of FIG. 1.

### DETAILED DESCRIPTION

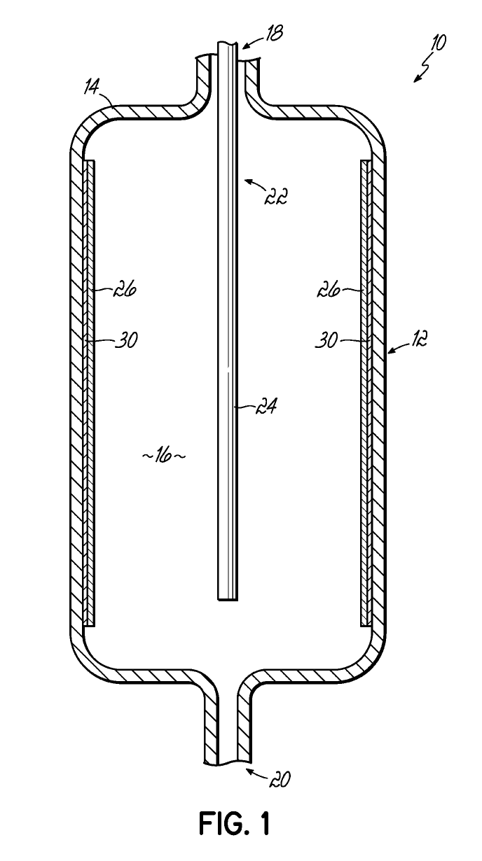

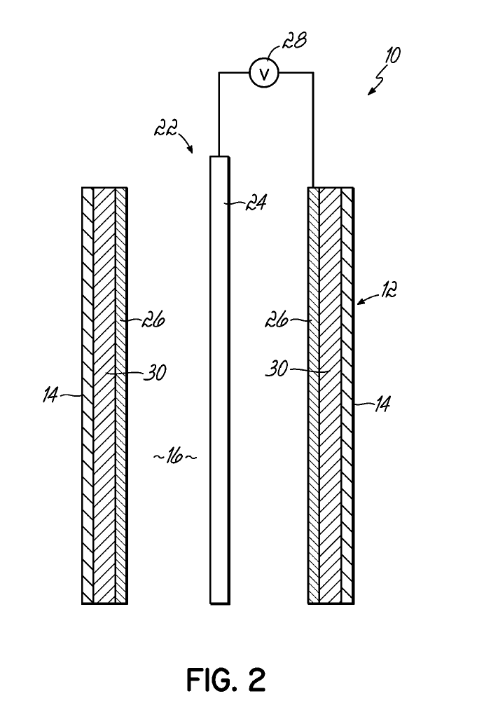

With respect to FIG. 1 and FIG. 2, a fluid processing system 10 includes a tank 12 having an outer wall 14. The tank 12 defines within it a reservoir 16 for holding a fluid. The fluid is directed into the reservoir 16 through an inlet 18 and may be evacuated from the reservoir 16 through an outlet 20. The fluid may be any fluid, such as a liquid, that conducts electricity therethrough. According to an exemplary embodiment, the fluid is introduced and evacuated from the tank 12 by one or more pumps (not shown) and conduits (not shown) fluidly connected to the inlet 18 and the outlet 20 and configured to direct the flow of the fluid. However, it will be appreciated that generally any mechanism for introducing and evacuating the fluid into and from the tank 12 may be so used.

The fluid processing system 10 also includes a heating element 22. The heating element 22 is generally situated within the reservoir 16 of the tank 12 and is configured to directly heat the fluid therein. The heating element 22 generally includes a first electrode 24 and a second electrode 26, both of which are formed of electrically conductive materials. The first electrode 24 and the second electrode 26 are generally spaced from each other within the tank 12. According to an exemplary embodiment, the first electrode 24 is generally centrally situated within the tank 12, while the second electrode 26 is situated generally near the outer wall 14 of the tank 12. More particularly, the tank 12 is generally cylindrical such that the outer wall 14 defines and surrounds a central longitudinal axis extending along a length of the tank 12. The first electrode 24 extends along the central axis of the tank 12, whereas the second electrode 26 is generally cylindrical. Thereby, the first electrode 24 is generally concentric with the second electrode 26. As shown, the first electrode 24 is rod-shaped and extends for a length along the central axis of the tank 12. As also shown, the second electrode 26 is generally cylinder-shaped and extends for a generally similar length as the first electrode 24. As shown in FIG. 1, the first electrode 24 is introduced into the tank 12 through the inlet 18, and the first and second electrodes 24, 26 extend along substantially the entire length of the tank 12. It will be appreciated that other electrode shapes and configurations could also be used.

An electric power supply 28 shown in FIG. 2 is configured to provide electric power to the heating element 22. In particular, the electric power supply 28 is connected to the first electrode 24 and the second electrode 26. The electric power supply 28 is configured to provide electric current, such as AC or DC power, to one or both of the first electrode 24 and second electrode 26. The fluid processing system 10 is advantageously used for processing the electrically conductive fluid. Thereby, the fluid in the reservoir 16 will conduct electricity between the first electrode 24 and the second electrode 26. For example, if electric current is provided to the first electrode 24, the electric current will travel through the fluid in the reservoir 16 to the second electrode 26. In a similar manner, if electric current is provided to the second electrode 26, the electric current will travel through the fluid in the reservoir 16 to the first electrode 24.

The fluid processing system 10 also includes an insulating element 30 within the outer wall 14 of the tank 12. In particular, the insulating element 30 is generally situated between the second electrode 26 and the outer wall 14 of the tank 12. The insulating element 30 provides both electrical and thermal insulation, thereby reducing or eliminating the electric current and heat from transferring from within the reservoir 16 to the outer wall 14. Advantageously, the insulating element 30 prevents any electricity from reaching the outer wall 14, and substantially reduces thermal transfer to the outer wall 14. The insulating element 30 is generally cylindrical and positioned against an inner surface of the outer wall 14. Similarly, the second electrode 26 is positioned against an inner surface of the insulating element 30, such that the insulating element 30 is sandwiched between the second electrode 26 and the outer wall 14. Thereby, an operator, or other person, in the vicinity of the outer wall 14 is inhibited from contacting a portion of the fluid processing system 10 electrically charged by the electric power supply 28 for reducing the likelihood of electric shock. Additionally, because the outer wall 14 of the tank 12 is insulated from heat transfer, the outer wall 14 can be constructed to have a thickness that is generally thinner than prior art designs, which were relatively thick in order to sustain the substantial amounts of heat imparted to the tank material. According to an exemplary embodiment, the insulating element 30 may be manufactured from alumina (Al₂O₃), silica (SiO₂), chromia (Cr₂O₃), magnesia (MgO), lime (CaO), or any mixture and ratio of these materials ratios configured to insulate the outer wall 14 electrically and thermally. As such, any neutral, acidic, or basic insulation material may be so used.

In use, the fluid processing system 10 shown in FIG. 1 and FIG. 2 is configured to process the fluid as follows. The fluid is introduced into the tank 12 through the inlet 18 such that the fluid resides within the reservoir 16. The heating element 22 is activated to process the fluid. In particular, the electric power supply 28 supplies electric current to the first electrode 24 and/or the second electrode 26. The fluid within the reservoir 16 conducts electricity from one electrode 24, 26 to the other electrode 26, 24. The electric current travels through the fluid by being directed between the first and second electrodes 24, 26. In any case, the transfer of electric current through the fluid, in turn, generates heat, which increases a temperature of the fluid to an appropriate, desirable temperature. According to an exemplary embodiment, the desirable temperature is a predetermined temperature configured to process the fluid and may be unique to the particular fluid being processed. While electrically heating the fluid, the insulating element 30 inhibits the electric current from migrating to the outer wall 14, and inhibits heat transfer from within the reservoir 16 to the outer wall 14 for improved operator safety and reduced energy consumption. After processing is complete, the processed fluid is evacuated from the reservoir 16 through the outlet 20 and may be used and/or recycled as will be appreciated in the art.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art.

The invention in its broader aspects is, therefore, not limited to the specific details, representative apparatus and method, and illustrative examples shown and described. Accordingly, departures may be made from such details without departing from the spirit or scope of the general inventive concept. What is claimed is:

1. A fluid processing system, comprising:
a tank configured to receive a fluid and having an outer wall;
a heating element situated in the tank and configured to be powered by an electrical power supply for heating the fluid, the heating element including a first electrode and a second electrode; and
an insulating element positioned in the tank between the second electrode and the outer wall of the tank, the insulating element configured to electrically insulate and thermally insulate the outer wall from an electric current and heat generated within the tank.

2. The fluid processing system of claim 1, further comprising:
an electric power supply operatively connected to the heating element and configured to provide the electric current to the heating element.

3. The fluid processing system of claim 1, wherein the tank is a generally cylindrical tank defining a longitudinally extending central axis, and the first electrode extends along the central axis.

4. The fluid processing system of claim 3, wherein the first electrode is generally concentric with the second electrode.

5. The fluid processing system of claim 4, wherein the first electrode is rod-shaped and the second electrode is cylinder-shaped.

6. The fluid processing system of claim 5, wherein the first and second electrodes have a generally similar length extending along the tank.

7. The fluid processing system of claim 6, wherein the first and second electrodes extend along substantially an entire length of the tank.

8. The fluid processing system of claim 1, wherein the insulating element is positioned against an inner surface of the outer wall of the tank.

9. The fluid processing system of claim 8, wherein the second electrode is positioned against an inner surface of the insulating element.

10. A method of processing a fluid using a processing system including a tank having an outer wall, a heating element situated in the tank, the heating element having a first electrode and a second electrode, and an insulating element positioned in the tank between the second electrode and the outer wall of the tank, the method comprising:
directing electric current between the first electrode and the second electrode to heat the fluid in the tank.

11. The method of claim 10, further comprising:
heating the fluid to a predetermined temperature.

12. The method of claim 11, further comprising:
introducing the fluid into the tank prior to heating the fluid to the predetermined temperature;
holding the fluid within the tank while heating the fluid to the predetermined temperature; and
evacuating the fluid from the tank after the fluid reaches the predetermined temperature.
